(19) United States
(12) Patent Application Publication
(10) Pub. No.: US 2006/0098448 A1
(43) Pub. Date: May 11, 2006

(54) Multiple spectrum marker and light assembly for vehicles

(76) Inventors: Mark Coast, San Diego, CA (US); Tracy Francis, San Diego, CA (US)

Correspondence Address: Richard A. Ryan, Suite 110, 8497 N. Millbrook, Fresno, CA, 93720, US

(21) Appl. No.: 10/983,180

(22) Filed: Nov. 6, 2004

(51) Int. Cl. F21V 7/00

(52) U.S. Cl. 362/517

(57) ABSTRACT

A multiple spectrum marker and light assembly for vehicles that is adapted to be mounted to the vehicle and configured to emit a visible light signal and a non-visible light signal. The visible light signal is generated from the vehicle's standard visible light bulbs. The non-visible light signal can be generated from an infrared, near-infrared light, an ultraviolet light or a radio signal and used when lights out driving conditions are desired or necessary. The non-visible light signal can also transmit a coded data signal that comprises information about the vehicle and its driver. In the preferred embodiment, both the front and rear vehicle lighting systems incorporate the multiple spectrum assembly of the present invention and the driver can selectively, except for the coded data signal, utilize the visible light source or the non-visible light source. The coded data signal can be used to assist law enforcement personnel.

### CROSS-REFERENCE TO RELATED APPLICATIONS

None.

### BACKGROUND OF THE INVENTION

A. Field of the Invention

The field of the present invention relates generally to marker and light assemblies for vehicles, namely to vehicle running, brake and lighting systems. More particularly, the present invention relates to such marker and light assemblies that are specially adapted for vehicle use at night when a “lights out” driving condition is desired. Even more particularly the present invention relates to such marker and light assemblies that utilize visible and non-visible light spectrums to mark the position, braking and approaching condition of a vehicle and the non-visible spectrum to transmit data about the vehicle and/or its occupant through a coded data signal.

B. Background

As is well known in the vehicle industry, virtually all vehicles have front lighting systems that project a forward beam of light from the headlight or headlights of the vehicle and rear lighting systems that project rearward beams of lights from the tail lights and/or brake lights. The typical headlight is a somewhat standard visible light emitting lamp that is configured to light the area in front of the vehicle to allow the driver of the vehicle see the road or terrain in front of him or her and to facilitate other vehicles being able to see the vehicle, whether approaching or moving in a different direction. The typical vehicle also has one or more tail lights that are cooperatively configured to be lit when the forward directed headlights are on and are utilized to assist persons in a following vehicle to know the general location and direction of the leading vehicle. Vehicle brake lights are generally configured to remain off until the driver of the vehicle activates the vehicle's braking system, typically by placing pressure on the brake pedal with his or her foot. In normal situations, it is the intent of the vehicle lighting systems to project a visible light with the headlights so as to illuminate the area in front of the vehicle, to mark the position of the rear of the vehicle with a visible light and to utilize visible light brake lights to selectively warn those following that the vehicle is slowing or stopping. In addition to these lights, the typical vehicle also has a plurality of turning lights to indicate from the front and rear of the vehicle that the vehicle will be making a left or right turn or be generally moving to the left or right (i.e., changing lanes). Because it is the intent of the typical vehicle lighting system that these lights be directly seen with the human eye and processed by the human brain when the vehicle is in use, the lamps utilized for vehicle front and rear lighting systems are configured to project light in that part of the light spectrum which is visible to humans.

Under certain conditions, however, it is desirable that the vehicle lights be turned off so that the vehicle, and its occupants and/or cargo, cannot be easily located or identified by other persons. For instance, during training and combat situations it is not uncommon for the military to have to move vehicles at night across terrain in which it is desirable that the movement of the vehicles not be easy to see or track. During combat operations or the occupation of a war torn country, it is often preferable to move military units from one position to another under the cover of darkness. As well understood, utilizing darkness to move troops from one location to another provides an element of surprise to the enemy and reduces the ability of the enemy to attack the troops when they are at their most vulnerable (movement in vehicles). In order to sustain an attack on the enemy, bring in fresh supplies or to provide aid to the citizens and other noncombatants in the area, it is often necessary to also move very large quantities of commercial goods from a safe staging area to an area of risk. Under the combat or occupation circumstances, it is often preferable to have commercial vehicles move the necessary cargo, typically in a convoy or other group of vehicles, under cover of darkness to avoid detection and possible attack.

Moving military and/or commercial vehicles at night, under cover of darkness, can best be accomplished with the vehicle's lighting system turned off or disengaged, commonly referred to as a “lights out” condition. During lights out vehicle operation conditions, the drivers of the vehicles typically utilize night vision goggles or night sight systems to be able to “see” the road or terrain in front of them, to follow other vehicles in their group or convoy and to avoid colliding with other vehicles by using whatever small amount of light is available. Unfortunately, it is typical that a person's depth perception is greatly reduced or impaired by the use of the night vision goggles or night sight systems and the small amount of light generally available does not offset this problem. Because military and commercial vehicles only operate visible light beam systems, there is very little to assist the driver in determining the way he or she should be going and to prevent collisions with other vehicles. This is a particular problem with vehicles that move in a group or convoy. As the lead vehicles need to slow or stop, the vehicles following have little ability, due primarily to the depth perception problems of the night vision goggles or night sight systems, to determine that the lead vehicles are in fact slowing or stopping. As a result, it is not uncommon for there to be a number of vehicle collisions. Some of the vehicle collisions are severe enough to damage/disable the vehicle and/or injure the driver or passengers therein. During combat operations or situations where the group or convoy of vehicles is under attack, the likelihood of such collisions increase, as does the potential for disaster from such collisions (i.e., become easy targets for enemy combatants). Another problem with driving in a lights out condition, particularly in combat or convoy situations, is that one or more vehicles may lose sight of the leading vehicles and become separated from the main group of vehicles. In combat or hostile territory, such separation can be disastrous for the separated vehicles and their drivers and passengers.

In these days of increased terrorism concerns, it is also desirable to move certain materials in the United States at night. For instance, it may be much more desirable to accomplish the movement of nuclear, biological or certain chemical products at night in a manner that attracts as little attention as possible. One way to accomplish this is to be able to move the vehicles in a lights out condition. As with the combat or occupation circumstances discussed above, movement of such materials at night with the vehicle lights off may have certain terrorist-safety advantages, but it does create the potential for collisions between vehicles that can result in a separate but equally serious problems for those materials.

As a vehicle moves down the road, it is often necessary for persons in other vehicles, primarily law enforcement personnel such as the police, FBI and other law enforcement officers, to require information pertaining to the vehicle and/or its passengers. Currently, the law enforcement officer must enter the vehicle's license plate number to obtain information such as the make, model, vehicle identification number (VIN), the registered owner and information pertaining to the registered owner (hereinafter, this information is collectively referred to as the “vehicle information”). The primary method to obtain this information is to either call the license plate number into the law enforcement officer to radio into his or her office or to enter the information into an on-board vehicle computer system that is linked to a law enforcement database. From the information received by the officer, he or she can determine if the vehicle is stolen, there are warrants for the driver, the vehicle matches its license plate and other potentially important information. Unfortunately, the law enforcement officer must either first stop his or her vehicle to check on the suspect vehicle or check on the suspect vehicle while the officer is operating his or her vehicle. The process of checking on the suspect vehicle causes the officer to not devote full concentration to his or her driving and can potentially result in a collision or some other event. In addition, the amount of effort that it takes to check a suspect vehicle substantially limits the number of vehicles that the officer is likely to check.

As presently understood, there is no forward illuminating, rearward marking, turn signaling or braking light systems that are effective for use with vehicles during lights out operations (i.e., movement of the vehicles at night with the normal visible light lamps turned off) or for transmitting a coded data signal containing vehicle information to others. What is needed, therefore, is a forward lighting system for vehicles that utilizes the non-visible light spectrum to illuminate the path in front of the vehicle and a rearward lighting system for vehicles that utilizes the non-visible light spectrum to provide marking and braking indicators for following vehicles. A preferred forward and rearward lighting systems should comprise both visible and non-visible lights that can be selectively utilized by the driver to operate in lights on or lights off operations. The preferred forward lighting system should selectively utilize non-visible light to radiate the path in front of the vehicle and to provide an indicator to forward approaching vehicles of the general position and direction of the vehicle, in much the same way that is currently accomplished by headlights having visible light lamps. The preferred rearward lighting system should selectively utilize non-visible light to provide vehicle marking (i.e., tail lights) and to indicate that the vehicle is slowing or stopping (i.e., brake lights) in the same general way as currently only accomplished with visible light spectrum lamps. The preferred forward and rearward lighting systems would also utilize non-visible spectrum light to indicate a turn or a change in position of the vehicle during a lights out condition. The preferred system utilizing non-visible light spectrum lamps should allow the driver to choose whether to use the standard visible lighting system or the non-visible light spectrum system. In addition, the preferred multiple spectrum assembly should be configured to transmit a coded data signal containing vehicle information either in conjunction with the non-visible light signal or as an alternative to the non-visible light signal. Preferably, the assembly system is configured such that the non-visible light spectrum lamps transmits the coded data signal whether the visible or non-visible lights are activated.

### SUMMARY OF THE INVENTION

The multiple spectrum marker and light assembly for vehicles of the present invention solves the problems and provides the benefits identified above. That is to say, the present invention discloses new forward and rearward lighting systems for vehicles that allows improved operation of the vehicles at night, particularly in lights out conditions where the use of the vehicle's visible light lamps are not desired. The forward and reward lighting systems utilize lamp mechanisms that emit non-visible light spectrum light to illuminate the area in front of the vehicle and to provide marking and braking indicators at the rear of the vehicle. In the preferred embodiment the forward and rearward lighting systems are configured to allow the driver of the vehicle to selectively utilize the standard visible light spectrum lamps or to use the non-visible light lamps when lights out driving conditions are desired or warranted. In addition, the preferred embodiment transmits a coded data signal containing vehicle information from the non-visible light spectrum lamp. Use of the non-visible light system will improve the driver's visibility of the area in front of the vehicle, improve the ability of oncoming vehicles or persons to see the vehicle approaching, improve the ability of vehicles following to track the position and movement of the lead vehicle and improve the ability of the following vehicle to recognize and react to the lead vehicle slowing down or stopping. The use of non-visible light lamps systems will reduce the likelihood of collisions and vehicles being “lost” during lights out driving conditions. Use of the non-visible light lamps to transmit a coded data signal containing vehicle information will improve the ability of law enforcement personnel and others to acquire that information and do so in a safer manner.

In one general aspect of the present invention, the multiple spectrum marker and light assembly for vehicles of the present invention includes a visible light spectrum source, a non-visible light spectrum source and a switching system to select therebetween. The non-visible light spectrum source is configured to provide illumination and marking for the vehicle when lights out driving conditions are desired or necessary and to transmit a coded data signal containing vehicle information. The visible light spectrum source and the non-visible light spectrum source are mounted on the vehicle in cooperative arrangement, such as being part of a common headlight or taillight assembly. The switching system is in electrical communication with both the visible light spectrum source and the non-visible light spectrum source to allow selective engagement of the visible light spectrum source and/or the non-visible light spectrum source. The non-visible light spectrum source can be configured to transmit the coded data signal on a continuous basis while the vehicle is in operation (i.e., while driving). In a preferred embodiment, the multiple spectrum assembly is incorporated into the vehicle's front lighting system located at the front end of the vehicle and incorporated into the rear lighting system at the back end of the vehicle, with a switching system inside the vehicle and accessible by the driver. With the multiple spectrum assembly in use, the front lighting system will provide forward projecting illumination from either the visible or non-visible light spectrum sources positioned at the front end of the vehicle and rearward projecting illumination from either the visible or non-visible light spectrum sources positioned at the back end of the vehicle. The front lighting system is electrically connected to a battery of the vehicle. The rear lighting system is electrically connected to the battery and operatively connected to a braking system of the vehicle, such that the multiple spectrum assembly of the rear lighting system will selectively display visible light or non-visible light as a result of the operation of the braking system. The non-visible light spectrum source can be configured to emit an infrared light, a near-infrared light, an ultraviolet light or a radio signal and/or it can be configured to transmit a coded data signal containing vehicle information, preferably continuously while the vehicle is in operation. In one configuration of the present invention, both the visible light spectrum source and the non-visible light spectrum source are mounted to a light assembly backing plate.

In another aspect of the present invention, a system for providing illumination from a vehicle is set forth herein. The system comprises a front lighting system having one or more front multiple spectrum assemblies mounted to the front end of the vehicle, a rear lighting system having one or more back multiple spectrum assemblies mounted to a back end of the vehicle and a switching system in electrical communication with the front lighting system and the rear lighting system so as to allow selective engagement of the front multiple spectrum assembly and the rear multiple spectrum assembly so as to selectively emit a signal from the visible light spectrum sources and/or the non-visible light spectrum sources. The front multiple spectrum assemblies and the rear multiple spectrum assemblies both have a visible light spectrum source and a non-visible light spectrum source in cooperative arrangement with the visible light spectrum source. As above, the visible light spectrum source is configured to emit visible light from the front and back ends of the vehicle and the non-visible light spectrum is configured to emit non-visible light from the front and back ends of the vehicle. The rear lighting system is operatively connected to a braking system of the vehicle and configured to selectively display visible light or non-visible light as a result of the operation of the braking system. The non-visible light spectrum source for the system can comprise an infrared light, a near-infrared light, an ultraviolet light or a radio signal and it can be configured to transmit, preferably continuously while the vehicle is in use, a coded data signal. As with the above, the visible light spectrum source and the non-visible light spectrum source can be mounted to a light assembly backing plate.

Accordingly, the primary objective of the present invention is to provide a multiple spectrum marker and light assembly for vehicles that provides the advantages discussed above and that overcomes the disadvantages and limitations associated with presently available vehicle “lights out” lighting systems.

It is also an object of the present invention to provide a multiple spectrum marker and light assembly for vehicles that provides forward and rearward lighting systems that emit lights in both the visible and non-visible light spectrums.

It is also an object of the present invention to provide a multiple spectrum marker and light assembly for vehicles that has a forward lighting system that is configured to selectively illuminate the area in front of the vehicle with visible light lamps or non-visible light spectrum lamps.

It is also an object of the present invention to provide a multiple spectrum marker and light assembly for vehicles that has a rearward lighting system that is configured to selectively display marking and braking lights with visible light lamps or non-visible light spectrum lamps.

It is also an object of the present invention to provide a multiple spectrum marker and light assembly for vehicles that has a turn signaling system that utilizes non-visible light to allow the driver of the vehicle to indicate a turn or change in vehicle position.

It is also an object of the present invention to provide a multiple spectrum marker and light assembly for vehicles that comprises a forward lighting system and a rearward lighting system having lamps that emit light in the non-visible light spectrum for driving the vehicle in a lights out condition.

It is also an object of the present invention to provide a multiple spectrum marker and light assembly for vehicles that comprises a non-visible light spectrum lamp that is configured to transmit a coded data signal containing vehicle information.

The above and other objectives of the present invention will be explained in greater detail by reference to the attached figures and the description of the preferred embodiment which follows. As set forth herein, the present invention resides in the novel features of form, construction, mode of operation and combination of processes presently described and understood by the claims.

### BRIEF DESCRIPTION OF THE DRAWINGS

In the drawings which illustrate the preferred embodiments and the best modes presently contemplated for carrying out the present invention:

FIG. 1 is front view of a multiple spectrum marker and light assembly for vehicles mounted on a light assembly backing plate and configured according to a preferred embodiment of the present invention;

FIG. 2 is a side view of a vehicle equipped with a multiple spectrum marker and light assembly according to a preferred embodiment of the present invention;

FIG. 3 is a front perspective view of the vehicle of FIG. 2 showing the multiple spectrum marker and light assembly of the present invention mounted to the front thereof;

FIG. 4 is a rear perspective view of the vehicle of FIG. 2 showing the multiple spectrum marker and light assembly of the present invention mounted to the front thereof;

FIG. 5 is front view of a switching system for use with the multiple spectrum marker and light assembly of the present invention;

FIG. 6 is a schematic of a front lighting system for use with the multiple spectrum marker and light assembly of the present invention; and

FIG. 7 is a schematic of a rear lighting system for use with the multiple spectrum marker and light assembly of the present invention.

### DETAILED DESCRIPTION OF THE PREFERRED EMBODIMENTS

With reference to the figures where like elements have been given like numerical designations to facilitate the reader's understanding of the present invention, and particularly with reference to the embodiment of the multiple spectrum marker and light assembly for vehicles of the present invention illustrated in the figures, various preferred embodiments of the present invention are set forth below. The enclosed description and drawings are merely illustrative of preferred embodiments and represent several different ways of configuring the present invention. Although specific components, materials, configurations and uses of the present invention are illustrated and set forth in this disclosure, it should be understood that a number of variations to the components and to the configuration of those components described herein and in the accompanying figures can be made without changing the scope and function of the invention set forth herein.

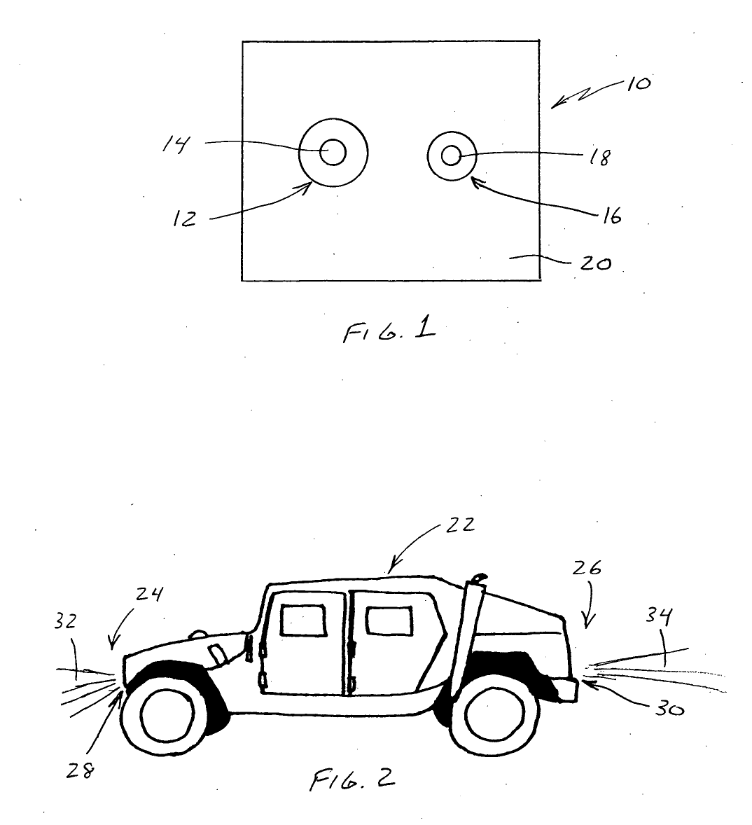

In the preferred embodiment of the multiple spectrum marker and light assembly for vehicles of the present invention, shown in the figures, multiple spectrum assembly is identified generally as 10 and best shown in FIG. 1. As explained in more detail below, multiple spectrum assembly 10 primarily comprises a standard visible light spectrum source 12, such as those having a two filament incandescent, LED or other type of visible light emitting light bulb 14, and a non-visible light spectrum source 16 having a non-visible emitting light bulb 18. In the embodiment shown in FIG. 1, visible light spectrum source 12 and non-visible light spectrum source 16 are mounted to a light assembly backing plate 20. As set forth more fully below, FIGS. 2 through 4 included herewith show the use of the multiple spectrum assembly 10 with a military-type vehicle 22. Although the present disclosure shows the use of multiple spectrum assembly 10 with light assembly backing plate 20, and in conjunction with the use of the military-type vehicle 22, the invention is not so limited. As is well known to those skilled in the art, visible light spectrum source 12 and non-visible light spectrum source 16 can be mounted or attached to a vehicle, such as vehicle 22, in a variety of different ways, with or without backing plate 20 and in a configuration where visible light spectrum source 12 and non-visible light spectrum source 16 are adjacent or separated some distance. The vehicle with which multiple spectrum assembly 10 of the present invention can be used can be the military-type of vehicle 22 or any number of different types of vehicles, including automobiles, motorcycles, pick-up trucks, delivery trucks, boats and others. The references to the specific vehicle 22 is for exemplary purposes only and is in no way intended to limit the scope of the multiple spectrum assembly of the present invention 10 to vehicle 22.

As best shown in FIG. 2, vehicle 22 has front end 24 and a back end 26 with a front lighting system 28 located generally at front end 24 and a rear lighting system 30 located generally at back end 26. As is well known with regard to vehicles generally, front lighting system 28 is configured to emit a forward projecting illumination 32 and rear lighting system 30 is configured to emit a rearward projecting illumination 34. Forward projecting illumination 32 is configured to illuminate the area in front of vehicle 22 to assist the driver of vehicle 22 in driving along the desired path or in the desired direction. Forward projecting illumination 32 also assist drivers in vehicles that may be approaching vehicle 22, whether from the forward or a side direction, to see vehicle 22 and identify the direction from which it is approaching or in which it is moving. As a result forward projecting illumination 32 reduces the likelihood of head-on or side collisions that may otherwise occur at night if there were no forward projecting illumination 32. Rearward projecting illumination 34 is generally configured to mark the forward position of vehicle 22 relative to another vehicle following or otherwise positioned behind vehicle 22 and to indicate to the following vehicle that vehicle 22 has initiated braking action to slow or stop vehicle 22. With rearward projecting illumination 34, a second vehicle is able to follow the direction of vehicle 22 and to react to the slowing or stopping of vehicle 22 to avoid colliding into vehicle 22. In presently available vehicle 22, both forward 32 and rearward 34 projecting illumination is achieved with light that falls within the spectrum of light that is visible to the human eye. The improvement of the multiple spectrum assembly 10 of the present invention is to permit both forward and rearward 34 illumination with non-visible spectrum light so that vehicle 22 can be effectively and safely utilized in lights out condition.

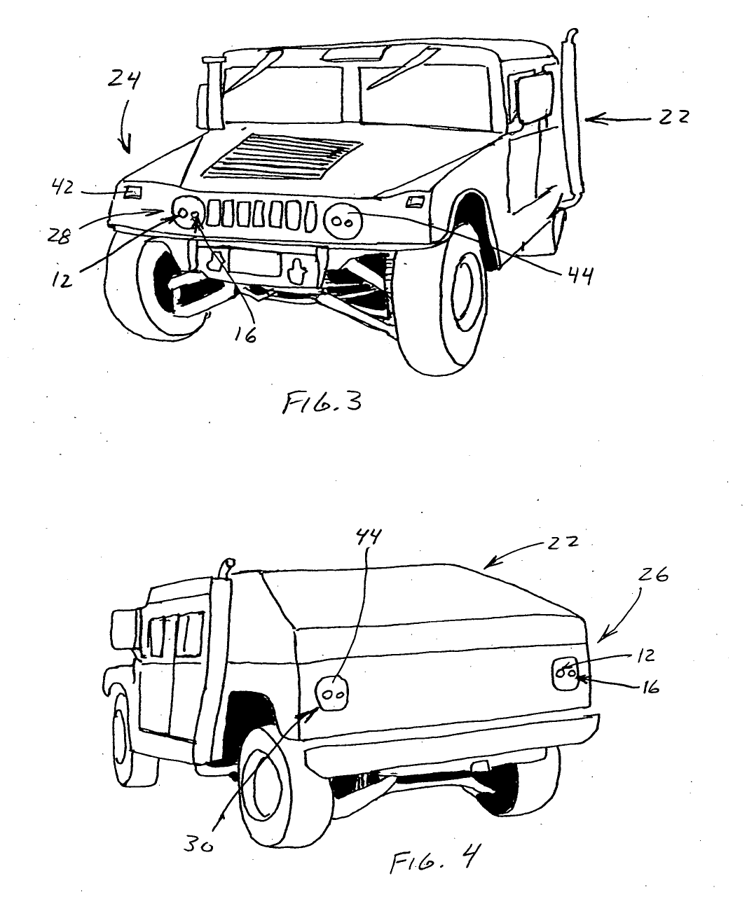

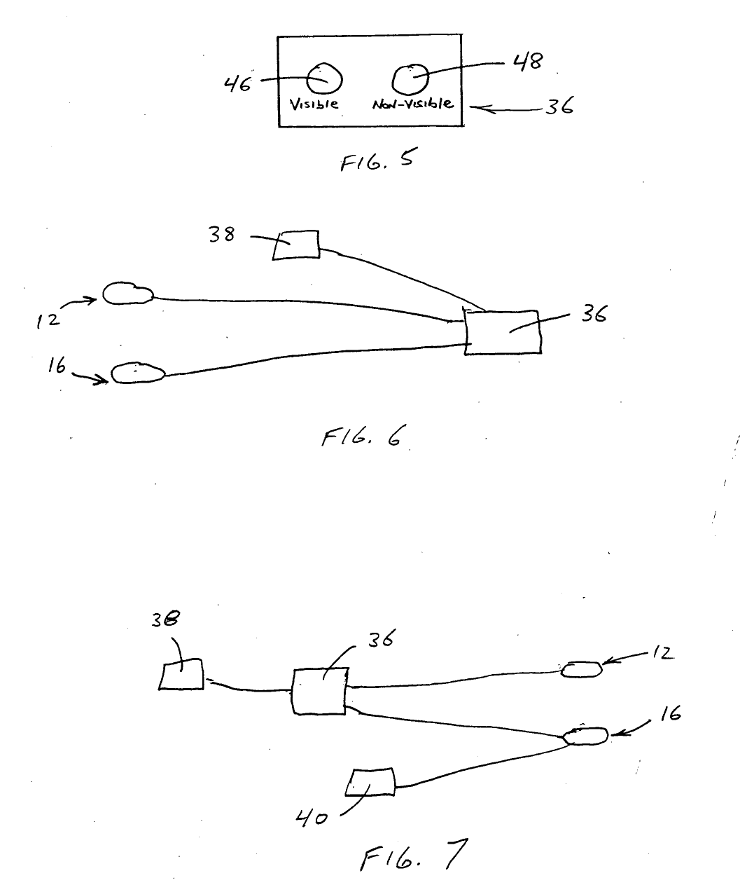

As shown in FIG. 3, front end 24 of vehicle 22 has the standard forward facing visible light spectrum source 12 having a visible light bulb 14 therein that typically comprises a two filament incandescent LED or visible light emitting light bulb that allows the driver to select between normal, low beam lighting and high beam or bright lighting. For use in lights out condition, when use of visible light spectrum source 12 is forbidden or to be avoided, the invention herein comprises non-visible light spectrum source 16, which comprises non-visible light bulb 18. In one embodiment, non-visible light spectrum source 16 can include bulb 18 mounted in a socket (not shown) and electrically connected to a switching system 36, such as shown generally in FIG. 5, inside the driver's compartment and to the vehicle's electrical system, shown generally in FIG. 6 for front lighting system 28 with battery 38 for one set of visible 12 and non-visible 16 light spectrum sources. In this manner, the driver of vehicle 22 can selectively chose to utilize visible light spectrum source 12 or non-visible light spectrum source 16, depending on whether lights out driving conditions are warranted or desired. As known to those skilled in the art, non-visible light spectrum source 16 can include many of the same components currently utilized with visible light spectrum source 12, such as a housing or other support to mount to front end 24, protective grills or plates to prevent damage from rocks or other debris, and adjustment mechanisms to adjust the vertical and or horizontal illumination (none of which are shown) for non-visible light bulb 18.

As shown in FIG. 4, back end 26 of vehicle 22 has the standard rearward facing visible light spectrum source 12 having a visible light bulb 14 therein that typically comprises a two filament incandescent LED or visible light emitting light bulb that provides marking lights (i.e., tail lights) that illuminate with the activation of visible light spectrum source 12 and brake warning lights (brake lights) that are typically activated by the driver pressing his or her foot against the brake pedal. For use in lights out condition, when use of visible light spectrum source 1 is forbidden or to be avoided, the invention herein further comprises non-visible light spectrum source 16, which may comprise a non-visible light bulb 18. As with the front lighting system 28 described above, in one embodiment of the present invention, non-visible light spectrum source 16 of rear lighting system can include bulb 18 mounted in a socket (not shown) and electrically connected to switching system 36, shown generally in FIG. 5, inside the driver compartment and to the vehicle's electrical system, shown generally in FIG. 7 for rear lighting system 30 with battery 38 for one set of visible 12 and non-visible 16 light spectrum sources. In addition, as known to those skilled in the art, non-visible spectrum light source 16 of rear lighting system 30 is operatively connected to the vehicle's braking system, shown generally as 40 in FIG. 7, such that when the driver activates the brakes during a lights out condition, non-visible light spectrum source 16 will emit a signal so any following vehicles will know that the forward vehicle is slowing or stopping to avoid colliding with the back end 26 of vehicle 22. The driver of vehicle 22 can selectively chose to utilize visible light spectrum source 12 or non-visible light spectrum source 16, depending on whether lights out driving conditions are warranted or desired. When non-visible light spectrum source is selected, rear lighting system 30 will illuminate non-visible light bulb 18 as the taillight and the brake light (when braking system 40 is activated). As known to those skilled in the art, non-visible light spectrum source 16 can include many of the same components currently utilized with the back end 26 visible light spectrum source 12, such as a housing or other support to mount to back end 26, protective grills or plates to prevent damage from rocks or other debris, and adjustment mechanisms to adjust the vertical and or horizontal illumination (none of which are shown) for non-visible light bulb 18.

As generally well known, most vehicles have turn signal lights at the front and back ends of the vehicle to enable the driver of the vehicle to signal his or her intention to either make a turn with the vehicle (i.e., right or left turn) or to move from one side of the road or path (i.e., changing lanes). Typically, the front lighting system 28 includes a separate turn signal lamp 42 located at front end 24 of vehicle 22 that is configured to be electrically connected to battery 38 and to a driver-operated switching system (not shown) located in the driver compartment of vehicle 22. As with the currently available light sources on vehicle 22, the typical turn signal lamp 42 comprises a visible light bulb 14, or equivalent, that allows the turn signal to be seen directly by the human eye. In many vehicles, the rear turn signal is incorporated into the visible light spectrum source 12 unit that functions as the taillight and the brake light. Like the front turn signal lamp 42, the rear turn signal serves the purpose of signaling a turn or change in position for vehicle 22. Generally, a flasher adapter (not shown) is utilized to cause the signal light to flash at a predetermined rate to perform the signal function. In the preferred embodiment of the multiple spectrum assembly 10 of the present invention, the turn signals, including front turn signal lamp 42, also incorporate a non-visible light spectrum source 16 so that the signal can be utilized in a lights out condition. As with the front 28 and rear 30 lighting systems, turn signal lamp 42 and the rear turn signal would be operatively connected to switching system 36 so the driver or an occupant of vehicle 22 can switch the turn signal lights to their non-visible light spectrum sources when it is desired to move vehicle 22 in a lights out condition.

As known to those skilled in the art, various types of non-visible light components are suitable for use as non-visible light spectrum source 16. For instance, non-visible light bulb can be of the type that emits infrared, near-infrared, ultraviolet, radio or other types of non-visual light signals. Such sources of non-visible light signals in the form of non-visible light bulb 18 are generally available for a variety of non-visible light operations. Heretofore, the use of such non-visible light sources in conjunction with a visible light source to allow the driver or another person to selectively chose between such systems when lights out driving conditions are or are not desired or necessary has not been available. In a preferred embodiment, multiple spectrum assembly 10, primarily comprising visible light spectrum source 12, non-visible light spectrum source 16 and switching system 36 are configured and operated in much the same way that the standard lighting system is presently configured and operated, except that the user can choose whether he or she wants the front 28 and rear 30 lighting systems to emit visible light or non-visible light signals.

In a preferred embodiment, multiple spectrum assembly 10 comprises much of the same components utilized for the standard visible light spectrum source 12, namely wiring to electrically connect assembly 10 to battery 38 and an on/off switch, a housing (not shown) to enclose and protect assembly 10, a reflector element (not shown) to reflect the light outward, a lens cover 44, a bulb socket for receiving visible light bulb 14 and visible light bulb 14. The improvement provided by multiple spectrum assembly 10 of the present invention comprises the addition of switching system 36 to allow the driver or another person to selectively choose between the visible and non-visible light systems, additional electrical circuitry to connect non-visible light spectrum source 16 to switching system 36, a socket for non-visible light bulb 18 and non-visible light bulb 18. As shown in FIG. 5, switching system 36 comprises mechanism for selecting the visible light spectrum source 12 or the non-visible light spectrum source 16, such as the use of separate visible light switch 46 and non-visible light switch 48. In a preferred embodiment, shown in FIGS. 1, 3 and 4, visible light bulb 14 and non-visible light bulb 18 can share the same housing, reflector element and lens cover 44. In another embodiment, the visible and non-visible light systems can utilize separate housings, reflector elements and lens covers 44. In yet other embodiments, different non-visible light bulbs 18 can be utilized for the rear taillights, brake lights and turning lights. Also, non-visible light spectrum source 16 can comprise one or more non-visible light bulbs 18.

In use, multiple spectrum assembly 10 of the present invention is installed and utilized in much the same way as conventional vehicle lighting systems, except that the driver or user can selectively choose to have the lighting systems emit visible or non-visible light. In a preferred embodiment, both visible light spectrum source 12 and non-visible light spectrum source 16 are disposed inside the same headlight housing and utilize the same reflector element and lens cover 44 and are both electrically connected to switching system 36 and battery 38 (for the front 28 and rear 30 lighting systems) and to the braking system 40 (for rear lighting system 30). In use under normal, non-lights out condition, the user activates visible light switch 46 to emit visible light from visible light spectrum sources 12 at the front end 24 and back end 26 of vehicle 22. The vehicle's headlights, taillights, brake lights and turning lights will function as is known in the prior art to emit visible light for forward projecting illumination 32 and rearward projecting illumination 34. When lights out driving condition is desired, the driver will deactivate the visible light spectrum source 12, if on, and activate non-visible light switch 48 on switching system 36 to emit a non-visible light signal from non-visible light spectrum source 16 from non-visible light bulb 18 at front end 24 and back end 26 of vehicle 22. Like the visible light system, use of non-visible light spectrum source 16 at the front end 24 (the front multiple spectrum assembly 10) will provide forward projecting illumination 32 to illuminate the area in front of vehicle 22, and provide an indicator to vehicles that may be approaching from the opposite direction and illuminate front turn signal lamp 42 when the driver activates the turn signal switch. In addition, non-visible light spectrum source 16 at the back end 26 (the back multiple spectrum assembly 10) will provide rearward projecting illumination 34 to function as the taillights, brake lights and turning lights at the back end 26 of vehicle 22. Instead of projecting visible light, the non-visible light bulb 18 (which can be infrared, near-infrared, ultraviolet, radio or other types of non-visual light signals) will project a non-visible light signal that can be easily viewed by the driver or other persons in vehicle 22 and by persons in other vehicles who are wearing night vision goggles or night sight systems. The forward projecting illumination 32 provided by non-visible light spectrum source 16 at the front end 24 of vehicle 22 will allow the driver to see the area in front of vehicle 22. The rearward projecting illumination 34 at the back end 26 of vehicle 22 will allow, through the use of night vision goggles or night sight systems, other drivers in vehicles behind vehicle 22 to see the direction taken by vehicle 22 (taillights), the slowing or stopping of vehicle 22 (brake lights) and any turning or changing lanes by vehicle 22 (turn signals). As with the standard visible light systems, the activation of non-visible light spectrum sources 16 at the front end 24 and back end 26 of vehicle 22 is selectively chosen function as a mechanism to assist the driver of vehicle 22 and the drivers of other vehicles to avoid driving away from the desired road or path, avoid collision with objects near the driving path and avoid collisions with other vehicles.

In an alternative embodiment of the present invention, switching system 36 can be configured to allow the driver or another person associated with vehicle 22 to activate simultaneously both visible light spectrum source 12 and non-visible light spectrum source 16. Multiple spectrum assembly 10 of the present invention can be modified to function with a variety of different types of vehicles, including automobiles, trucks, motorcycles, boats and other vehicles. The configuration of the various components utilized with multiple spectrum assembly 10 of the present invention can be modified as necessary to function with these different types of vehicles. Vehicles presently having only a visible light spectrum source 12 can have the front 28 and/or rear 30 lighting systems modified to include non-visible light spectrum source 16 to provide the benefits of the multiple spectrum assembly 10 described herein.

In another preferred embodiment, multiple spectrum assembly 10 comprises a non-visible light spectrum source 16 configured to transmit a coded data signal (shown embedded in forward projecting illumination 32 and rearward projecting illumination 34 in FIG. 3) containing vehicle information. The coded data signal is configured to work in conjunction with law enforcement personnel vehicles such that the officer inside the vehicle can access the vehicle information without having to phone in the license plate number to the office or enter that information into the officer's on-board computer system. As stated above, the coded data signal would comprise information pertaining to the vehicle and to the owner or other person associated with the vehicle. As known by those skilled in the art, the coded data signal can be transmitted over a non-visible light frequency, such as greater than 60 Hz, and be capable of transmitting a wide range of information pertaining to the vehicle and/or driver of the vehicle. The multiple spectrum assembly 10 of the present invention can be electrically connected to the suspect vehicle's on-board computer chip, frequently utilized in most newer vehicles, through an intermediary encrypting device that is suitable for sending the information through non-visible light spectrum source 16 in a coded pulse. In the preferred embodiment, the generation of the coded data signal is not part of switching system 36 such that whenever vehicle 22 is in use (i.e., being driven) it is broadcasting the coded data signal. In this manner any law enforcement vehicle equipped with an appropriate receiver can receive the coded data signal and review the vehicle information without having to call in the license plate number or check his or her on-board computer. As is likely apparent to those involved in law enforcement and the like, this will have certain advantages over the present ways of obtaining such information, including improving efficiency and safety. In addition, if a vehicle is reported stolen or involved in some crime, the law enforcement computer system can flag the relevant vehicle information and be electronically “looking” for the suspect vehicle such that when the on-board computer recognizes the appropriate coded data signal, the law enforcement officer can pull over the vehicle or call for assistance before pulling the over the vehicle. This last aspect of the coded data signal use can be particularly important when the vehicle may be in use by a dangerous criminal or a person suspected of committing a dangerous or violent crime (and as such may not want to be pulled over). With the coded data signal from the multiple spectrum assembly 10 of the present invention, the law enforcement officer can be forewarned of that possibility.

While there are shown and described herein certain specific alternative forms of the invention, it will be readily apparent to those skilled in the art that the invention is not so limited, but is susceptible to various modifications and rearrangements in design and materials without departing from the spirit and scope of the invention. In particular, it should be noted that the present invention is subject to modification with regard to assembly, materials, size, shape and use.

What is claimed is:

1. A multiple spectrum assembly for a vehicle, said multiple spectrum assembly comprising:
a visible light spectrum source coupled to the vehicle and configured to emit visible light from the vehicle;
a non-visible light spectrum source coupled to the vehicle and configured to emit non-visible light from the vehicle, said non-visible light spectrum source in cooperative arrangement with said visible light spectrum source; and
a switching system in electrical communication with said visible light spectrum source and said non-visible light spectrum source to allow selective engagement of said visible light spectrum source and/or said non-visible light spectrum source.

2. The multiple spectrum assembly according to claim 1, wherein the vehicle has a front end and opposite facing a back end, said front end of the vehicle having a front lighting system and said back end of the vehicle having a rear lighting system, said front lighting system configured to provide forward projecting illumination from said multiple spectrum assembly positioned at said front end of the vehicle, said rear lighting system configured to provide rearward projecting illumination from said multiple spectrum assembly positioned at said back end of the vehicle.

3. The multiple spectrum assembly according to claim 2, wherein said front lighting system is electrically connected to a battery of the vehicle and said rear lighting system is electrically connected to said battery and operatively connected to a braking system of the vehicle.

4. The multiple spectrum assembly according to claim 3, wherein said multiple spectrum assembly of said rear lighting system is configured to selectively display visible light or non-visible light as a result of the operation of said braking system.

5. The multiple spectrum assembly according to claim 4, wherein said non-visible light spectrum source comprises an infrared light, a near-infrared light, an ultraviolet light or a radio signal.

6. The multiple spectrum assembly according to claim 5, wherein said non-visible light spectrum source further comprises a coded data signal containing vehicle information.

7. The multiple spectrum assembly according to claim 6, wherein said coded data signal is emitted from said non-visible light spectrum source independently of said switching system.

8. The multiple spectrum assembly according to claim 1, wherein said visible light spectrum source has one or more visible light bulbs and said non-visible light spectrum source has one or more non-visible light bulbs.

9. The multiple spectrum assembly according to claim 1, wherein said visible light spectrum source and said non-visible light spectrum source are mounted to a light assembly backing plate.

10. The multiple spectrum assembly according to claim 1, wherein said non-visible light spectrum source comprises an infrared light, a near-infrared light, an ultraviolet light or a radio signal.

11. The multiple spectrum assembly according to claim 10, wherein said non-visible light spectrum source further comprises a coded data signal containing vehicle information.

12. The multiple spectrum assembly according to claim 11, wherein said coded data signal is emitted from said non-visible light spectrum source independently of said switching system.

13. The multiple spectrum assembly according to claim 1, wherein the vehicle has a plurality of multiple spectrum assemblies, each of said plurality of multiple spectrum assemblies comprising a pair of said visible light spectrum source and said non-visible light spectrum source.

14. A multiple spectrum assembly for a vehicle, said multiple spectrum assembly comprising:
a visible light spectrum source coupled to the vehicle and configured to emit visible light from the vehicle; and
a non-visible light spectrum source coupled to the vehicle and configured to emit non-visible light and/or a coded data signal from the vehicle, said non-visible light spectrum source in cooperative arrangement with said visible light spectrum source, said coded data signal comprising vehicle information.

15. The multiple spectrum assembly according to claim 14 further comprising a switching system in electrical communication with said visible light spectrum source and said non-visible light spectrum source to allow selective engagement of said visible light spectrum source and/or said non-visible light spectrum source.

16. The multiple spectrum assembly according to claim 15, wherein said coded data signal is not controlled by said switching system so that the vehicle transmits said coded data signal whenever the vehicle is in use.

17. The multiple spectrum assembly according to claim 14, wherein the non-visible light is emitted from said visible light spectrum source comprising an infrared light, a near-infrared light, an ultraviolet light or a radio signal.

18. A system for providing illumination from a vehicle, said system comprising:
a front lighting system having one or more front multiple spectrum assemblies mounted to a front end of the vehicle, each of said one or more front multiple spectrum assemblies having a visible light spectrum source and a non-visible light spectrum source in cooperative arrangement with said visible light spectrum source, said visible light spectrum source configured to emit visible light from said front end of the vehicle and said non-visible light spectrum configured to emit non-visible light from said front end of the vehicle;
a rear lighting system having one or more back multiple spectrum assemblies mounted to a back end of the vehicle, each of said one or more back multiple spectrum assemblies having a visible light spectrum source and a non-visible light spectrum source in cooperative arrangement with said visible light spectrum source, said visible light spectrum source configured to emit visible light from said back end of the vehicle and said non-visible light spectrum configured to emit non-visible light from said back end of the vehicle; and
a switching system in electrical communication with said front lighting system and said rear lighting system to allow selective engagement of said one or more front multiple spectrum assemblies and said one or more rear multiple spectrum assemblies to selectively activate said visible light spectrum sources and/or said non-visible light spectrum sources.

19. The vehicle illumination system according to claim 18, wherein said rear lighting system is operatively connected to a braking system of the vehicle and configured to selectively display visible light or non-visible light as a result of the operation of said braking system.

20. The vehicle illumination system according to claim 19, wherein said non-visible light spectrum source comprises an infrared light, a near-infrared light, an ultraviolet light or a radio signal.

21. The vehicle illumination system according to claim 20, wherein said non-visible light spectrum source further comprises a coded data signal containing vehicle information.

22. The multiple spectrum assembly according to claim 21, wherein said coded data signal is emitted from said non-visible light spectrum source independently of said switching system.

23. The vehicle illumination system according to claim 18, wherein said non-visible light spectrum source comprise an infrared light, a near-infrared light, an ultraviolet light and/or a radio signal.

24. The multiple spectrum assembly according to claim 18, wherein said non-visible light spectrum source comprises a coded data signal containing vehicle information.

25. The multiple spectrum assembly according to claim 24, wherein said coded data signal is emitted from said non-visible light spectrum source independently of said switching system.

26. The vehicle illumination system according to claim 18, wherein a pair of said visible light spectrum source and said non-visible light spectrum source are mounted to a light assembly backing plate.
